(19) United States
(12) Patent Application Publication
(10) Pub. No.: US 2016/0345546 A1
(43) Pub. Date: Dec. 1, 2016

(54) WATER HEATER WITH MOUNTING ERROR PROTECTION

(71) Applicant: EIKO ELECTRIC PRODUCTS CORP., Taipei City (TW)

(72) Inventor: Yu-Chin WANG, Taipei City (TW)

(21) Appl. No.: 14/724,834

(22) Filed: May 29, 2015

(51) Int. Cl. A01K 63/06; H05B 1/02; H01H 35/02

(52) U.S. Cl. CPC A01K 63/065; H01H 35/02; H05B 1/0222

(57) ABSTRACT

A water heater includes a water heater main unit and a control circuit unit connected in parallel. The control circuit unit includes a circuit board carrying a water permeation safety control device and a tilt angle sensor switch. The water permeation safety control device includes an auto power-off safety device for automatically interrupts electrical current if water is permeated in the control circuit unit. If the water heater is installed in a wrong direction or tilted over a predetermined angle, the angle sensor switch automatically switches off the circuit.

### BACKGROUND OF THE INVENTION

1. Field of the Invention

The present invention relates to water heating technology and more particularly, to a water heater for use in an aquarium, which automatically cuts off power supply if it is installed in a reversed direction or tilted over a predetermined angle, assuring a high level of operational safety.

2. Description of the Related Art

A water heater for aquarium is to be merged in water in an aquarium for heating water when electrically conducted, keeping water in the aquarium within a predetermined temperature range for breading aquarium fish.

According to conventional water heater designs for aquarium, a heating wire is mounted around a mica or ceramic element and then inserted with the mica or ceramic element and a heater control circuit in a glass tube or other temperature resistant insulation tube. A water heater of this kind has the drawback of low heating efficiency due to indirect heating. Further, because the heater control circuit is mounted with the heating wire in the glass tube, the components of the heater control circuit can easily be damaged by heat during the operation of the water heater.

Using a direct heating type water heater can prohibit heater control circuit from thermal damage. In a direct heating type water heater, the heater control circuit is disposed outside the heating unit, enhancing heating efficiency and protecting components of the heater control circuit from thermal damage.

### SUMMARY OF THE INVENTION

The present invention has been accomplished under the circumstances in view. It is one object of the present invention to provide a water heater, which automatically interrupts electrical current upon permeation of water, assuring a high level of operational safety. It is another object of the present invention to provide a water heater, which switches off the circuit if it is installed in a wrong direction or tilted over a specific angle, assuring a high level of operational safety.

To achieve these and other objects of the present invention, a water heater comprises a water heater main unit adapted for heating the water passing therethrough, and a control circuit unit mounted at one lateral side of the water heater main unit in a parallel manner. The control circuit unit comprises a circuit board mounted therein, and a heater control circuit installed in the circuit board for controlling the operation of the water heater main unit. The heater control circuit comprises a water permeation safety control device and a tilt angle sensor switch. The water permeation safety control device is a water permeation protection circuit installed in the heater control circuit. The water permeation protection circuit comprises a water sensor switch, a comparator circuit electrically connected to the water sensor switch, a normally open AC electrically connected to the comparator circuit, and an auto power-off safety device electrically connected to the comparator circuit.

Preferably, the resistors and the thermal fuse are integrally sealed on the circuit board.

Preferably, the circuit board heater control circuit further comprises a tilt angle sensor switch.

Preferably, the tilt angle sensor switch is ball switch type tilt angle sensor switch.

### BRIEF DESCRIPTION OF THE DRAWINGS

FIG. 1 is a perspective view of a water heater in accordance with the present invention.

FIG. 2 is a schematic applied view of the present invention, illustrating the water heat accurately mounted in water in an aquarium at the set angle.

FIG. 2A is a schematic sectional view of the auto power-off safety device of the water permeation protection circuit.

FIG. 3 is a schematic drawing illustrating different status of the tilt angle sensor switch when the water heater installed in water in various different installation positions.

FIG. 4 is a schematic drawing illustrating a condition of the tilt angle sensor switch when the water heater installed in water in a reversed direction.

FIG. 5 is a circuit diagram of the water permeation protection circuit of the water heater in accordance with the present invention.

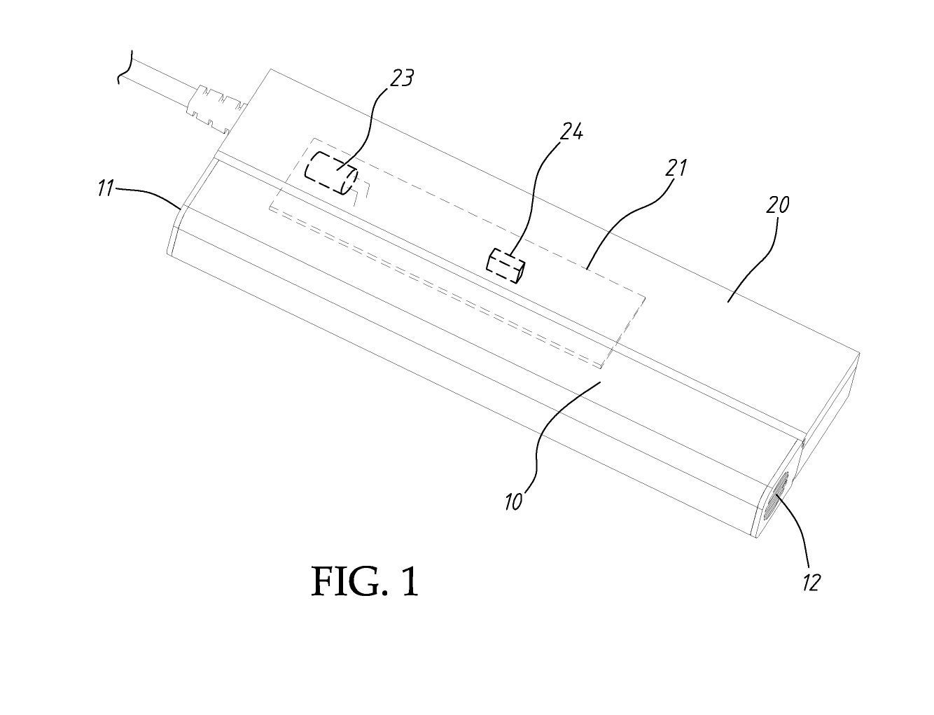

### DETAILED DESCRIPTION OF THE PREFERRED EMBODIMENT

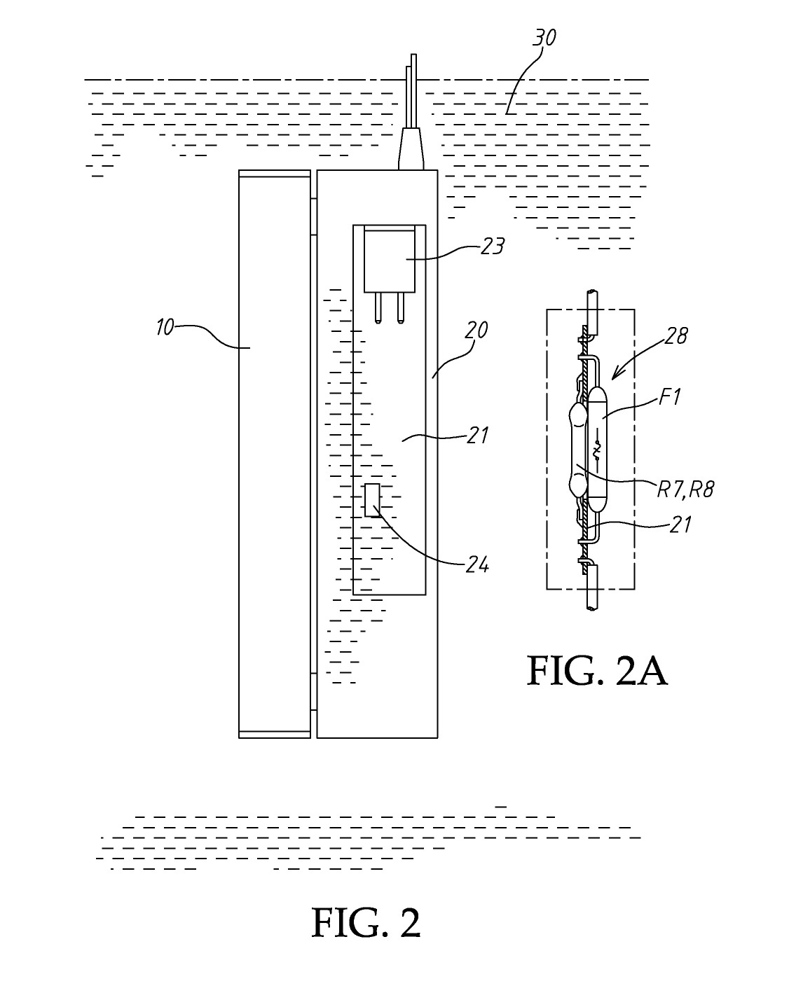

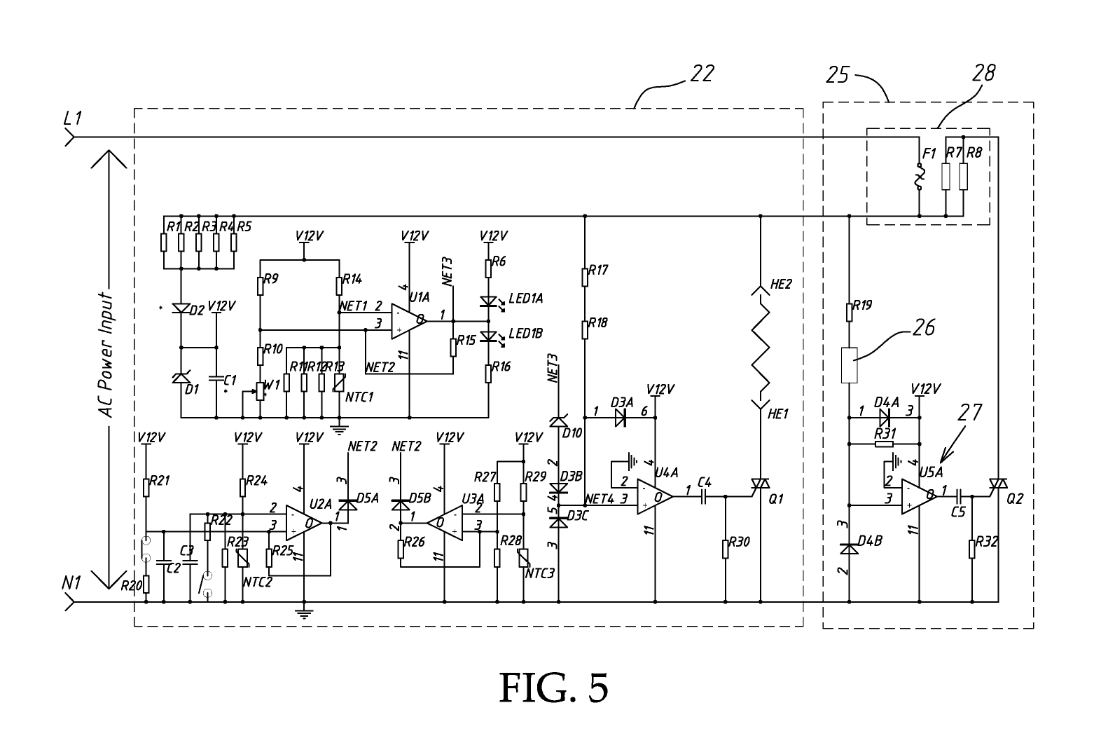

Referring to FIG. 2, a water heater with mounting error protection in accordance with the present invention is shown. The water heater protection structure comprises a water heater main unit 10, and a control circuit unit 20 mounted at one lateral side of the water heater main unit 10 in a parallel manner. The water heater main unit 10 comprises a cold water inlet 11 located at one end thereof, a hot/warm water outlet 12 located at an opposite end thereof, a water tube (not shown) connected between the cold water inlet 11 and the hot/warm water outlet 12, and a heating wire or heating film (not shown) surrounding the water tube. Thus, cold water can be guided through the cold water inlet 11 into the water tube in the water heater main unit 10 and then heated heat energy generated by the heating wire or heating film to a predetermined temperature level and then guided out of the water tube and the water heater main unit 10 through the hot/warm water outlet 12. The control circuit unit 20 comprises a circuit board 21 mounted therein, and a heater control circuit 22 installed in the circuit board 21 (see FIG. 5). The heater control circuit 22 comprises a tilt angle sensor switch 23 and a water permeation safety control device 24. After the water heater main unit 10 and the control circuit unit 20 are assembled, the water heater can be mounted in water 30 in, for example, an aquarium, at a predetermined angle in a predetermined up-down direction, as shown in FIG. 2.

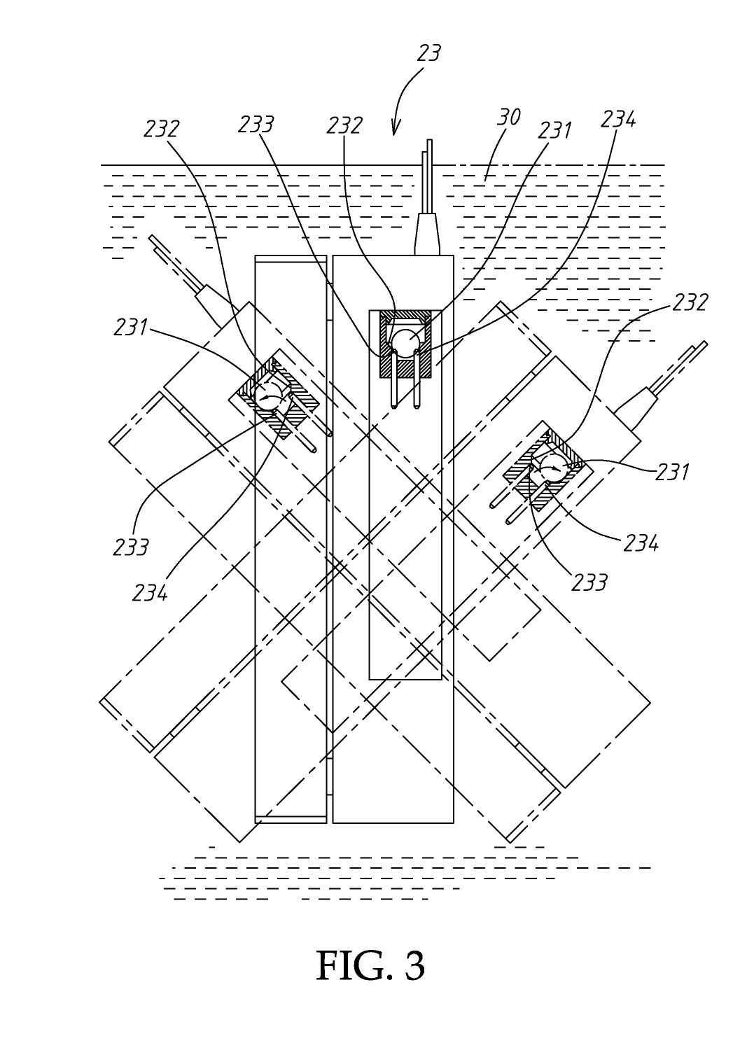

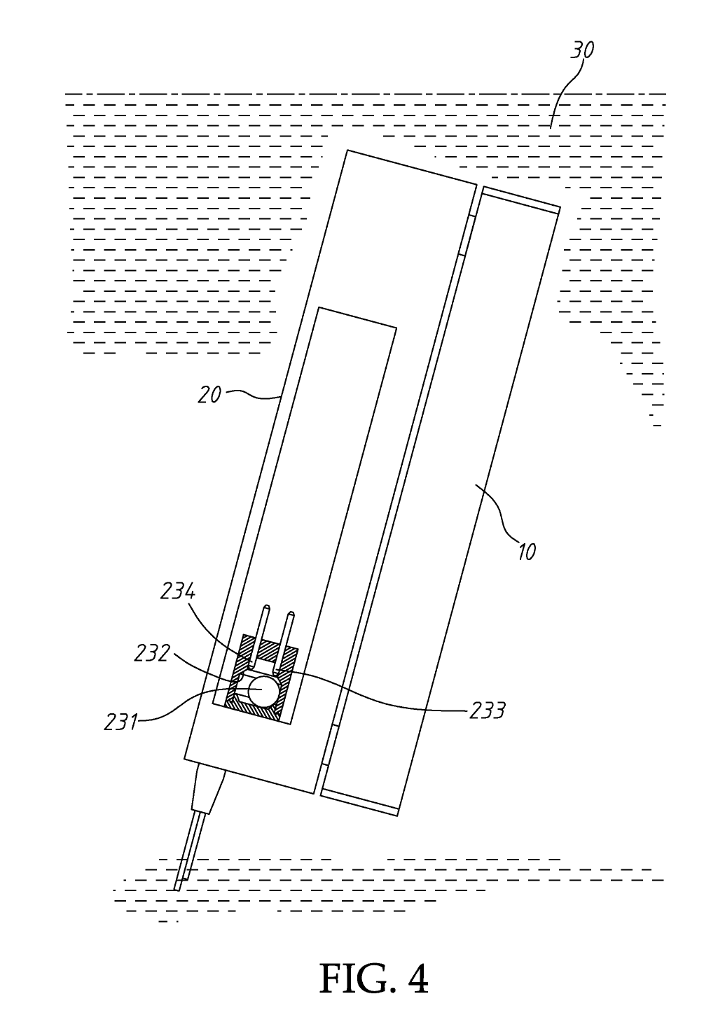

Referring to FIG. 3, the tilt angle sensor switch 23 is the present preferred embodiment is a ball switch type tilt angle sensor switch, comprising an inwardly sloping conical surface 232 defined therein, a steel ball 231 movably supported on the inwardly sloping conical surface 232, and a first contact 233 and a second contact 234 spaced at one side relative to the inwardly sloping conical surface 232. Subject to the gravitational effect, the steel ball 231 is normally kept in contact with the first contact 233 and the second contact 234, conducting the circuit. However, if the water heater is not accurately installed and tilted over a predetermined angle (for example, 45°), the steel ball 231 can simply be kept in contact with the first contact 233 (for example, tilted leftward over 45°) or the second contact 234 (for example, tilted rightward over 45°) to power off the water heater, providing protection. Referring also to FIG. 4, if the water heater is installed in a reversed direction, the steel ball 231 will be kept away from the first contact 233 and the second contact 234 to power off the water heater, providing protection.

Referring to FIG. 5, the water permeation safety control device 24 is a water permeation protection circuit 25 installed in the heater control circuit 22. The water permeation protection circuit 25 comprises a water sensor switch 26, a comparator circuit 27 electrically connected to the water sensor switch 26 and comprising a diode D4B for pin potential comparison and a normally open AC silicon controlled rectifier Q2, and an auto power-off safety device 28 electrically connected to the comparator circuit 27. The auto power-off safety device 28 comprises a plurality of resistors R7;R8 and a thermal fuse F1. As shown in FIG. 2A and FIG. 5, resistors R7;R8 and a thermal fuse F1 are integrally sealed on the circuit board 21 and adapted for interrupting electric current when heated to a specific temperature. When the water sensor switch 26 detects a change in resistance due to the presence of water, the comparator circuit 27 drives the AC silicon controlled rectifier Q2 to conduct the auto power-off safety device 28, causing the resistors R7;R8 to release heat due to a rise in resistance value, and thus, the thermal fuse F1 will interrupt electrical current when heated to the predetermined temperature level.

The water heater made by fastening the water heater main unit 10 and the control circuit unit 20 together can directly heat water, achieving optimal heating efficiency and preventing circuit damage due to a long use. Further, if the water heater is installed in a wrong direction or in a tilted manner over a predetermined angle, it will automatically interrupts electrical current, assuring a high level of operational safety.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A water heater, comprising a water heater main unit adapted for heating the water passing therethrough and a control circuit unit mounted at one lateral side of said water heater main unit in a parallel manner, said control circuit unit comprising a circuit board mounted therein and a heater control circuit installed in said circuit board for controlling the operation of said water heater main unit, said heater control circuit comprising a water permeation safety control device, said water permeation safety control device being a water permeation protection circuit, said water permeation protection circuit comprising a water sensor switch, a comparator circuit electrically connected to said water sensor switch, a normally open AC electrically connected to said comparator circuit, and an auto power-off safety device electrically connected to said comparator circuit.

2. The water heater as claimed in claim 1, wherein said auto power-off safety device comprises a plurality of resistors and a thermal fuse electrically connected to said resistors.

3. The water heater as claimed in claim 2, wherein said resistors and said thermal fuse are integrally sealed on said circuit board.

4. The water heater as claimed in claim 1, wherein said circuit board heater control circuit further comprises a tilt angle sensor switch.

5. The water heater as claimed in claim 4, wherein said tilt angle sensor switch is a ball switch type tilt angle sensor switch.

6. A water heater, comprising a water heater main unit adapted for heating the water passing therethrough and a control circuit unit mounted at one lateral side of said water heater main unit in a parallel manner, said control circuit unit comprising a circuit board mounted therein and a heater control circuit installed in said circuit board for controlling the operation of said water heater main unit, said heater control circuit comprising a water permeation safety control device and a tilt angle sensor switch, said water permeation safety control device being a water permeation protection circuit installed in said heater control circuit, said water permeation protection circuit comprising a water sensor switch, a comparator circuit electrically connected to said water sensor switch, a normally open AC electrically connected to said comparator circuit, and an auto power-off safety device electrically connected to said comparator circuit.

7. The water heater as claimed in claim 6, wherein said resistors and said thermal fuse are integrally sealed on said circuit board.

8. The water heater as claimed in claim 7, wherein said circuit board heater control circuit further comprises a tilt angle sensor switch.

9. The water heater as claimed in claim 6, wherein said tilt angle sensor switch is a ball switch type tilt angle sensor switch.
